(19) United States
(12) Patent Application Publication
(10) Pub. No.: US 2007/0058316 A1
(43) Pub. Date: Mar. 15, 2007

(54) Semiconductor device having fuse circuits

(75) Inventors: Jong-Hyoung Lim, Hwaseong-si (KR); Sang-Seok Kang, Suwon-si (KR); Yong-Hwan Jeong, Hwaseong-si (KR); Sang-Man Byun, Suwon-si (KR)

Correspondence Address: MILLS & ONELLO LLP, ELEVEN BEACON STREET, SUITE 605, BOSTON, MA, 02108, US

(73) Assignee: Samsung Electronics Co., Ltd.

(21) Appl. No.: 11/495,296

(22) Filed: Jul. 28, 2006

(30) Foreign Application Priority Data
Sep. 13, 2005 (KR) 10-2005-0085431

(51) Int. Cl. H02H 5/04

(52) U.S. Cl. 361/104

(57) ABSTRACT

Provided is a semiconductor device including a plurality of fuse circuits. Each of the fuse circuits includes: a first signal generator generating a first signal to a first node in response to a power-up signal; a pull-down transistor pulling down a second node in response to the first signal; a pull-up transistor and a fuse which are connected in series between a power supply voltage and the second node and pulling up the second node in response to the first signal when the fuse is not cut; a buffer buffering a signal output from the second node and generating a control signal; and a standby reset transistor resetting the second node in response to the control signal output from the buffer, wherein the pull-down transistor and the standby reset transistor have threshold voltages lower than a threshold voltage of the buffer. Also, each of the fuse circuits further includes an active reset transistor resetting the second node in the active mode in response to the reset control signal. Accordingly, the semiconductor device can reduce an undesired leakage current when the fuse is not cut, and also prevent change in the state of the control signal when the fuse is cut.

This application claims priority to Korean Patent Application No. 2005-10-0085431, filed on Sep. 13, 2005, the contents of which are incorporated herein by reference in their entirety.

### BACKGROUND OF THE INVENTION

1. Field of the Invention

The present invention relates to a semiconductor device, and more particularly, to a semiconductor device having fuse circuits.

2. Description of Related Art

In general, a semiconductor device, such as a semiconductor memory device, includes a plurality of fuse circuits, and a plurality of control signals are set to different levels depending on whether fuses of the fuse circuits are cut or not, thus determining the operation of the semiconductor device.

FIG. 1 contains a block diagram illustrating the construction of a semiconductor memory device having conventional fuse circuits.

Referring to FIG. 1, the semiconductor memory device includes a command decoder 10, an active internal power supply voltage generator 12, a standby internal power supply voltage generator 14, n fuse circuits 16-1 to 16-n, and a power-up signal generator 18. Each fuse circuit 16-1 to 16-n includes inverters I1 to I3, a PMOS transistor P1, NMOS transistors N1 and N2, and a fuse F1. The inverter 12 includes a PMOS transistor P2 and an NMOS transistor N3, and the inverter 13 includes a PMOS transistor P3 and an NMOS transistor N4.

The command decoder 10 decodes an externally applied command signal COM and generates an active command ACT. The active internal power supply voltage generator 12 receives an externally applied external power supply voltage EVC and generates an active internal power supply voltage AIVC in response to the active command ACT. The standby internal power supply voltage generator 14 receives the external power supply voltage EVC and generates a standby internal power supply voltage SIVC. That is, the active internal power supply voltage generator 12 operates when the active command ACT is applied in an active mode, while the standby internal power supply voltage generator 14 operates when the external power supply voltage EVC is applied in both active and standby modes. The active internal power supply voltage AIVC and the standby internal power supply voltage SIVC generate an internal power supply voltage IVC. The power-up signal generator 18 receives the external power supply voltage EVC and generates a power-up signal PUP. The power-up signal PUP remains at a low level until the external power supply voltage EVC reaches a certain voltage level (for example, a threshold voltage level of the inverter I1), transitions to a high level when the external power supply voltage EVC is at the certain voltage level or higher, and then varies according to the level variation of the external power supply voltage EVC. The fuse circuits 16-1 to 16-n output n control signals S1 to Sn, respectively, each of which makes a level transition depending on whether the fuse F1 is cut when the power-up signal PUP is applied in the standby mode.

FIG. 2 is a graph of the power-up signal PUP, the external power supply voltage EVC, and the voltage at a node n1 versus time. The operation of the fuse circuit 16-1 will now be described with reference to FIG. 2.

First, when the fuse F1 is not cut, with the application of the external power supply voltage EVC, the power-up signal. PUP remains at a low level until the power-up signal generator 18 reaches a level of a threshold voltage Vt of the inverter I1 as shown in FIG. 2. In response to the low level of the power-up signal PUP, the inverter I1 leads a voltage level at the node n1 to be elevated with a level transition of the external power supply voltage EVC. Thus, when the voltage level at the node n1 reaches a threshold voltage or higher of the NMOS transistor N1, the NMOS transistor N1 is turned on so that a voltage at a node n2 is disabled to a low level, and the inverters I2 and I3 buffer the low-level signal at the node n2 and generate the control signal S1 of a low level. A circuit including the inverter I2 and the NMOS transistor N2 latches the low-level signal of the node n2. Thereafter, when the external power supply voltage EVC is equal to or higher than the threshold voltage Vt of the inverter I1, the power-up signal generator 18 leads the power-up signal PUP to make a low-to-high transition. That is, as shown in FIG. 2, when the power-up signal PUP is equal to or higher than the threshold voltage Vt of the inverter I1, the voltage at the node n1 is disabled to a low level. As a result, the PMOS transistor P1 is turned on so that the signal at the node n2 is enabled to a high level, and the inverters I2 and I3 buffer the high-level signal of the node n2 and generate the control signal S1 of a high level.

Next, when the fuse F1 is cut, with the application of the external power supply voltage EVC, the fuse circuit 16-1 performs the same operation as when the fuse F1 is not cut, from the application of the low-level power-up signal PUP to the disabling of the signal at the node n2 to a low level, as shown in FIG. 2. Thereafter, when the external power supply voltage EVC is equal to or higher than the threshold voltage Vt of the inverter I1, the power-up signal generator 18 leads the power-up signal PUP to make a low-to-high transition. That is, as shown in FIG. 2, when the power-up signal PUP is equal to or higher than the threshold voltage Vt of the inverter I1, the voltage of the node n1 is disabled to a low level. However, since the fuse F1 is cut, the signal at the node n2 remains at a low level, and thus the control signal S1 is generated at a low level.

Like the fuse circuit 16-1, other fuse circuits 16-2 to 16-n also generate high-level control signals S2 to Sn, respectively, when the fuse F1 is not cut and generate low-level control signals S2 to Sn, respectively, when the fuse F1 is cut.

In the fuse circuits 16-1 to 16-n shown in FIG. 1, when the fuse F1 is not cut, while the voltage level of the node n1 makes a high-to-low transition, both the PMOS transistor P1 and the NMOS transistor N2 are turned on. Thus, a current path is formed through the PMOS transistor P1, the fuse F1, and the NMOS transistor N1, so that an undesired leakage current flows through the current path.

After the voltage level of the node n1 makes the high-to-low transition, the PMOS transistor P1 is turned on so that the voltage level at the node n2 is elevated. However, when the internal power supply voltage IVC applied by the standby internal power supply voltage generator 14 in the standby mode does not reach a desired level (namely, a threshold voltage level of the NMOS transistor N3 of the inverter I2), the NMOS transistor N2 remains turned on until the internal power supply voltage IVC reaches a threshold voltage level of the inverter I2. Accordingly, a current path is formed through the PMOS transistor P1, the fuse F1, and the NMOS transistor N2 until the NMOS transistor N2 is turned off, so that an undesired leakage current flows through the current path.

Furthermore, in the fuse circuits 16-1 to 16-n shown in FIG. 1, when the fuse F1 is cut and a residue of the fuse F1 is left behind, the voltage level of the node n2 is gradually elevated over time, and thus the control signals S1-Sn may make a low-to-high transition.

### SUMMARY OF THE INVENTION

The invention provides a semiconductor device having fuse circuits that is capable of reducing an undesired leakage current that may be generated when a fuse is not cut.

The invention also provides a semiconductor device having fuse circuits that is capable of preventing change in the state of a control signal when a fuse is cut.

In one aspect, the present invention is directed to a semiconductor device having a plurality of fuse circuits, each fuse circuit comprising: a first signal generator generating a first signal to a first node in response to a power-up signal; a pull-down transistor pulling down a second node in response to the first signal; a pull-up transistor and a fuse which are connected in series between a power supply voltage and the second node and pulling up the second node in response to the first signal when the fuse is not cut; a buffer buffering a signal output from the second node and generating a control signal; and a standby reset transistor resetting the second node in response to the control signal output from the buffer. The pull-down transistor and the standby reset transistor have lower threshold voltages than that of the buffer.

In one embodiment, the buffer includes a first inverter and a second inverter that are cascade-connected to generate the control signal, the standby reset transistor resetting the second node in response to an output signal of the second inverter.

In another embodiment, the standby reset transistor is an NMOS transistor.

In another embodiment, the power supply voltage may be an external power supply voltage which is applied from an exterior.

In another embodiment, the device further comprises: a command decoder decoding an externally applied command signal and generating an active command; a standby internal power supply generator generating an internal power supply voltage in a standby mode and an active mode when receiving an external power supply voltage which is applied from an exterior; an active internal power supply voltage generator generating the internal power supply voltage using the external power supply voltage in response to the active command; a control signal generator generating a reset control signal, which is enabled for a predetermined duration of time, in response to the active command; and a power-up signal generator generating the power-up signal, which remains at a first level until the external power supply voltage reaches a predetermined level when receiving the external power supply voltage, makes a transition from the first level to a second level when the external power supply voltage reaches the predetermined level, and makes a transition with a level variation of the external power supply voltage.

In another embodiment, the active internal power supply may be the internal power supply voltage using the external power supply voltage until a voltage at the first node reaches a predetermined level.

In another embodiment, the power supply voltage generator generates an internal power supply voltage which is generated from an interior.

In another embodiment, each fuse circuit further includes an active reset transistor resetting the second node in response to the reset control signal.

In another embodiment, the active reset transistor has a lower threshold voltage than that of the buffer.

In another embodiment, the active reset transistor is an NMOS transistor.

According to another aspect, the present invention is directed to a semiconductor device comprising: a command decoder decoding an externally applied command signal and generating an active command; a standby internal power supply voltage generator generating an internal power supply voltage in a standby mode and an active mode when receiving an external power supply voltage; an active internal power supply voltage generator generating the internal power supply voltage using the external power supply voltage in response to the active command; a control signal generator generating a reset control signal, which is enabled for a predetermined duration of time, in response to the active command; a power-up signal generator generating a power-up signal, which remains at a first level until the external power supply voltage reaches a predetermined level when receiving the external power supply voltage, makes a transition from the first level to a second level when the external power supply voltage reaches the predetermined level, and makes a transition with a level variation of the external power supply voltage; and a plurality of fuse circuits, each fuse circuit including a first signal generator generating a first signal to a first node in response to the power-up signal, a pull-down transistor pulling down a second node in response to the first signal, a pull-up transistor and a fuse which are connected in series between a power supply voltage and the second node and pulling up the second node in repsonse to the first signal when the fuse is not cut, a buffer buffering a signal output from the second node and generating a control signal, a standby reset transistor resetting the second node in response to the control signal output from the buffer in the standby mode, and an active reset transistor resetting the second node in the active mode in response to the reset control signal.

In one embodiment, the buffer includes a first inverter and a second inverter that are cascade-connected to generate the control signal, and the standby reset transistor resets the second node in response to an output signal of the second inverter.

In another embodiment, the power supply voltage may be an external power supply voltage which is applied from an exterior.

In another embodiment, the power supply voltage generator generates an internal power supply voltage.

In another embodiment, the standby reset transistor and the active reset transistor have lower threshold voltages than that of the buffer.

In another embodiment, the standby reset transistor is an NMOS transistor.

In another embodiment, the active reset transistor is an NMOS transistor.

In another embodiment, the active internal power supply generator generates the internal power supply voltage using the external power supply voltage until a voltage at the first node reaches a predetermined level.

### BRIEF DESCRIPTION OF THE DRAWINGS

The foregoing and other objects, features and advantages of the invention will be apparent from the more particular description of exemplary embodiments of the invention, as illustrated in the accompanying drawings. The drawings are not necessarily to scale, emphasis instead being placed upon illustrating the principles of the invention.

FIG. 1 contains a block diagram illustrating the construction of a semiconductor memory device having conventional fuse circuits.

FIG. 2 is a graph of the power-up signal PUP, the external power supply voltage EVC, and the voltage at a node n1 versus time.

FIG. 3 contains a block diagram illustrating the construction of a semiconductor memory device having fuse circuits according to an exemplary embodiment of the present invention.

FIG. 4 contains a block diagram illustrating the construction of a semiconductor memory device having fuse circuits according to another exemplary embodiment of the present invention.

FIG. 5 contains a block diagram illustrating the construction of a semiconductor memory device having fuse circuits according to still another exemplary embodiment of the present invention.

### DETAILED DESCRPTION OF THE INVENTION

A semiconductor device having fuse circuits according to the present invention will now be described more fully hereinafter with reference to the accompanying drawings, in which exemplary embodiments of the invention are shown.

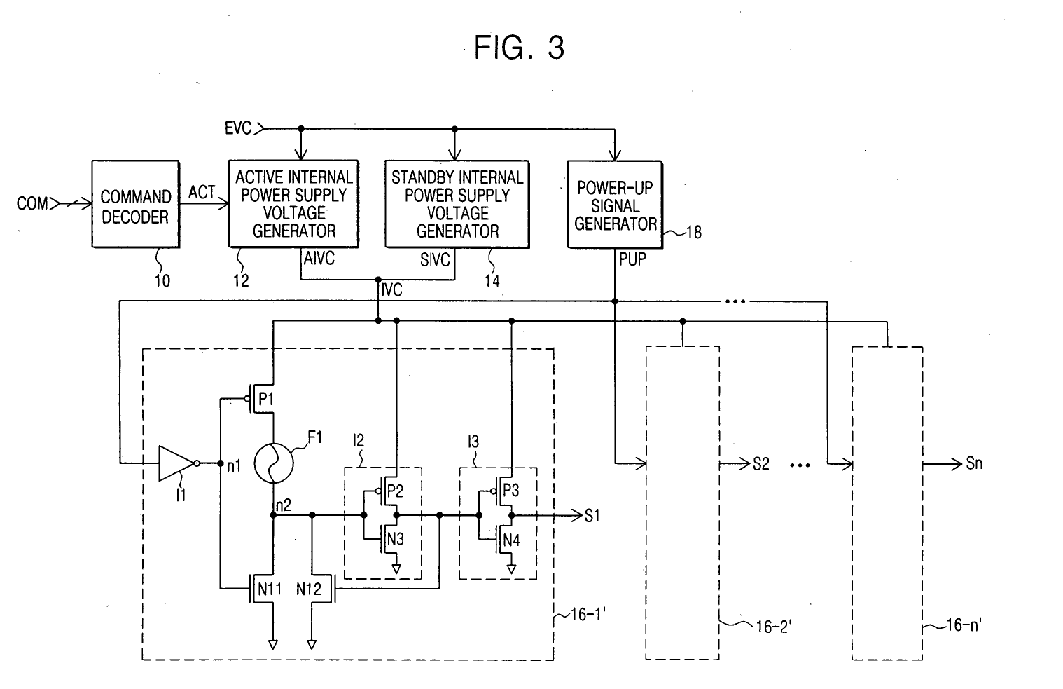

FIG. 3 contains a block diagram illustrating the construction of a semiconductor device having fuse circuits according to an exemplary embodiment of the present invention.

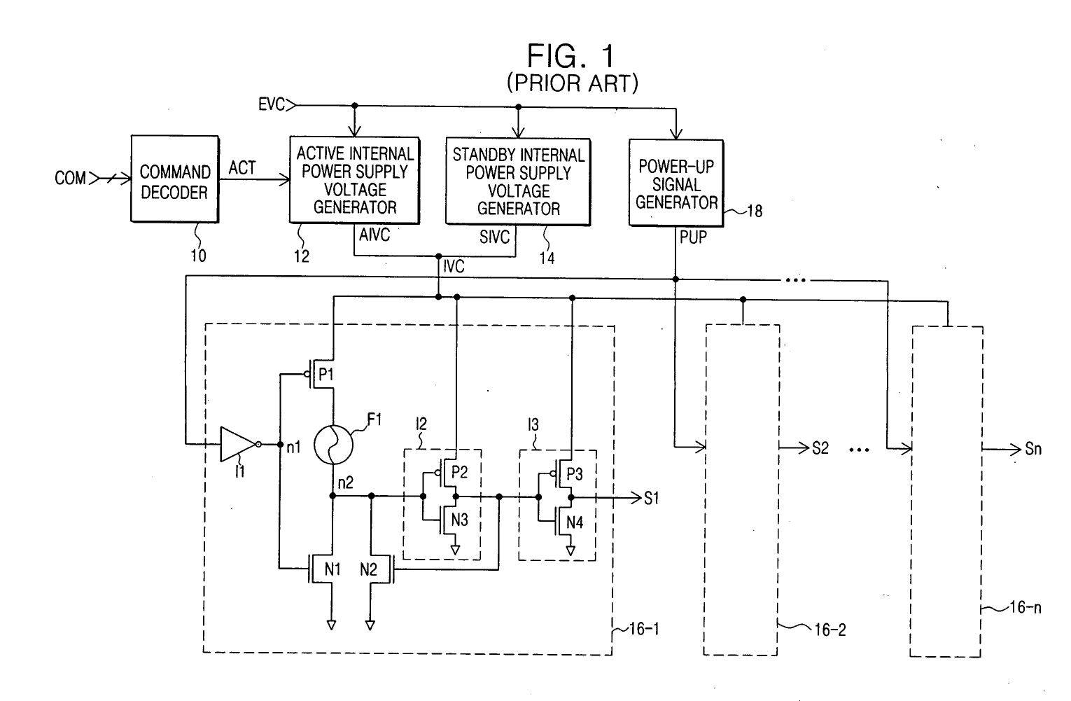

In FIG. 3, the semiconductor device has the same construction as the semiconductor device shown in FIG. 1 except that the semiconductor device of FIG. 3 includes n fuse circuits 16-1′ to 16-n′ instead of the fuse circuits 16-1 to 16-n. Also, the fuse circuits 16-1′ to 16-n′ have the same construction as the fuse circuits 16-1 to 16-n shown in FIG. 1 except that each of the fuse circuits 16-1′ to 16-n′ includes NMOS transistors N11 and N12 instead of the NMOS transistors N1 and N2.

In FIG. 3, the NMOS transistors N11 and N12 have threshold voltages lower than the threshold voltages of the NMOS transistors N1 and N2 and the threshold voltages of the NMOS transistors N3 and N4 of the inverters I2 and I3, shown in FIG. 1.

In FIG. 3, elements denoted by the same reference numerals used in FIG. 1 have the same functions described with reference to FIG. 1. Therefore, to avoid repetition of the description, only the fuse circuits 16-1′ to 16-n′ will be described here.

Operation of the fuse circuit 16-1′ is described below.

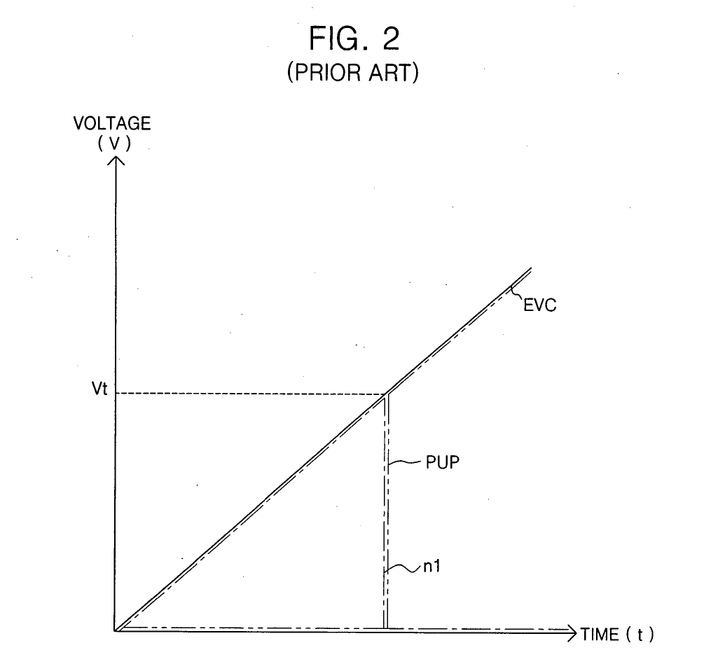

First, a case where a fuse F1 is not cut will be described. When an external power supply voltage EVC is applied and a power-up signal PUP having a low level is generated, a voltage at a node n1 is enabled to a high level until the external power supply voltage EVC reaches a threshold voltage Vt of an inverter I1 as shown in FIG. 2. Since the NMOS transistor N11 has a threshold voltage lower than the threshold voltage of the NMOS transistor N1 of FIG. 1, the NMOS transistor N11 is turned on earlier than a time point at which the NMOS transistor N1 of FIG. 1 is turned on so that a voltage at a node n2 is disabled to a low level, and the inverters I2 and I3 buffer the low-level signal of the node n2 and generate a control signal S1 of a low level. As a result, the fuse circuit 16-1′ generates the low-level control signal S1 earlier than the fuse circuit 16-1 of FIG. 1. A circuit having the inverter I2 and the NMOS transistor N2 latch the low-level signal of the node n2. Thereafter, as shown in FIG. 2, when the level of the external power supply voltage EVC is elevated and the power-up signal PUP is equal to or higher than the threshold voltage Vt of the inverter 11, the voltage at the node n1 makes a high-to-low transition. Then, both a PMOS transistor P1 and the NMOS transistor N11 are simultaneously turned on for a predetermined period. However, since the NMOS transistor N11 has a low threshold voltage, a smaller leakage current flows through the PMOS transistor P1 and the NMOS transistor N11 than in the NMOS transistor N1 of FIG. 1.

In the semiconductor device of FIG. 3, the fuse circuits 16-1′ to 16-n′ are designed such that the threshold voltages of the NMOS transistors N11 and N12 is lower than the threshold voltages of the inverters I1 to I3. As a result, the fuse circuits 16-1′ to 16-n′ can generate control signals S1 to Sn in a short period of time and reduce the flow of a leakage current through the NMOS transistors N11 and N12.

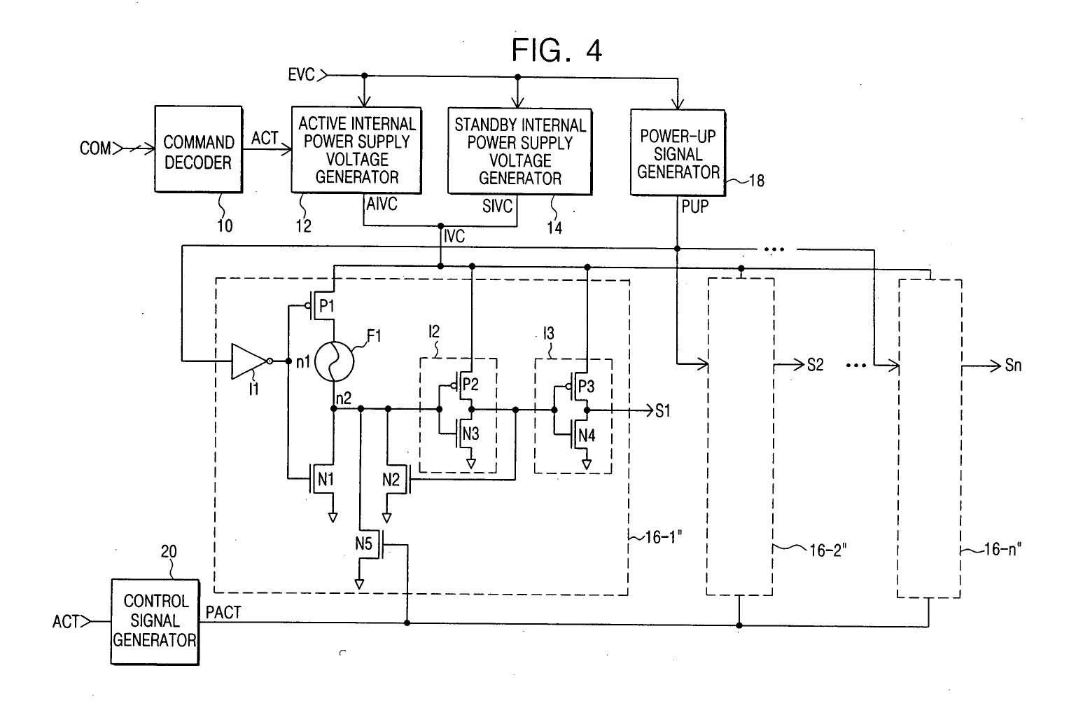

FIG. 4 contains a block diagram illustrating the construction of a semiconductor memory device having fuse circuits according to another exemplary embodiment of the present invention.

In FIG. 4, the semiconductor device has the same construction as the semiconductor device shown in FIG. 1 except that the semiconductor device of FIG. 4 includes n fuse circuits 16-1″ to 16-n″ instead of the fuse circuits 16-1 to 16-n and further includes a control signal generator 20. Also, the fuse circuits 16-1″ to 16-n″ have the same construction as the fuse circuits 16-1 to 16-n shown in FIG. 1 except that each of the fuse circuits 16-1″ to 16-n″ further includes an NMOS transistor N5.

In FIG. 4, elements denoted by the same reference numerals used in FIG. 1 have the same functions described with reference to FIG. 1. Therefore, to avoid repetition of the description, only the fuse circuits 16-1″ to 16-n″ and the control signal generator 20 will be described here.

When a fuse F1 is not cut, with application of an external power supply voltage EVC, generation of a power-up signal PUP of a low level results in generation of a control signal S1 of a low level in the same manner as described with reference to FIG. 1. Also, when the fuse F1 is not cut, with the application of the external power supply voltage EVC, generation of the power-up signal PUP of a high level results in generation of the control signal S1 of a high level in the same manner as described with reference to FIG. 1. In other words, a standby-mode operation performed from the application of the external power supply voltage EVC to application of an active command ACT is the same as the operation of the fuse circuit 16-1 of FIG. 1.

However, when the active command ACT is generated in an active mode, the control signal generator 20 generates a pulse control signal PACT, which is enabled to a high level for a predetermined duration of time, in response to the active command ACT. Then, the NMOS transistor N5 is turned on in response to the high-level pulse control signal PACT. Thus, when the fuse F1 is cut, the control signal S1 remains at a low level as determined in the standby mode. Also, when the fuse F1 is not cut, charges supplied from a generation terminal of an internal power supply voltage IVC to a node n2 are emitted to a ground voltage terminal. However, since the charges supplied to the node n2 are more than the emitted charges, the control signal S1 remains at a high level.

Accordingly, when the fuse F1 is cut, a drain of a PMOS transistor P1 is connected to the node n2 by residue of the fuse F1, and charges are supplied from the generation terminal of the internal power supply voltage IVC to the node n2, so that a voltage at the node n2 may be enabled to a high level. However, even if the voltage at the node n2 is enabled to a high level or before the voltage at the node n2 is enabled to the high level, the NMOS transistor N5 is turned on in response to the pulse control signal PACT, which is generated in response to the active command ACT in the active mode. Thus, charges are emitted from the node n2. As a result, when the fuse F1 is cut, the semiconductor device of the present embodiment can prevent change in the state of the control signal S1 due to the residue of the fuse F1. Also, even if the control signal S1 is enabled to a high level, the semiconductor device of the present embodiment can restore the control signal S1 to a low level.

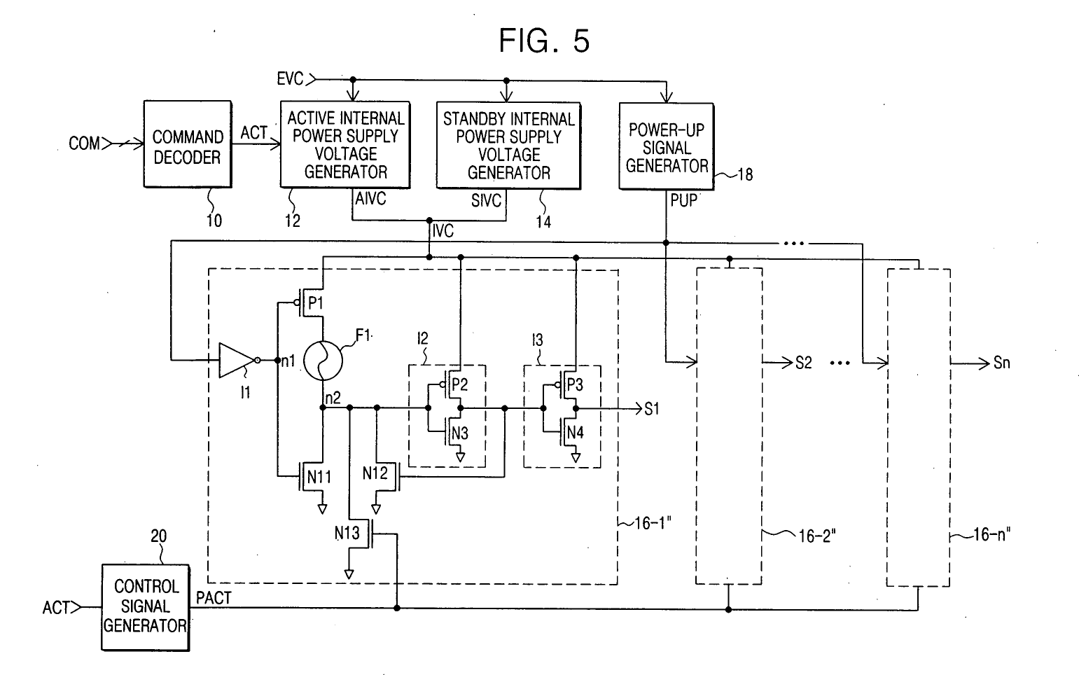

FIG. 5 contains a block diagram illustrating the construction of a semiconductor device having fuse circuits according to still another exemplary embodiment of the present invention.

In FIG. 5, the semiconductor device has the same construction as the semiconductor device shown in FIG. 4 except that the semiconductor device of FIG. 5 includes n fuse circuits 16-1′″ to 16-n′″ instead of the fuse circuits 16-1″ to 16-n″. Also, the fuse circuits 16-1′″ to 16-n′″ have the same construction as the fuse circuits 16-1″ to 16-n″ shown in FIG. 4 except that each of the fuse circuits 16-1′″ to 16-n′″ includes NMOS transistors N11, N12, and N13 instead of the NMOS transistors N1, N2, and N3.

In FIG. 5, the NMOS transistors N11, N12, and N13 have threshold voltages lower than the threshold voltages of the NMOS transistors N1, N2, and N3 shown in FIG. 4 and the threshold voltages of NMOS transistors N3 and N4 of inverters I2 and I3.

In FIG. 5, elements denoted by the same reference numerals used in FIG. 4 have the same functions described with reference to FIG. 4. Therefore, to avoid repetition of the description, only the fuse circuits 16-1′″ to 16-n′″ will be described here.

Operation of the fuse circuit 16-1′″ is described below.

When a fuse F1 is not cut, with application of an external power supply voltage EVC, generation of a power-up signal PUP of a low level results in generation of a control signal S1 of a low level in the same manner as described with reference to FIG. 3. Also, when the fuse F1 is not cut, with the application of the external power supply voltage EVC, generation of the power-up signal PUP of a high level results in generation of the control signal S1 of a high level in the same manner as described with reference to FIG. 3. That is, a standby-mode operation performed from the application of the external power supply voltage EVC to application of an active command ACT is the same as the operation of the fuse circuit 16-1′ of FIG. 3. Accordingly, since the NMOS transistors N11 and N12 have low threshold voltages, the fuse circuit 16-1′″ can generate the control signal S1 in a short period of time and reduce the flow of a leakage current through the NMOS transistors N11 and N12.

When an active command ACT is generated in an active mode, the fuse circuit 16-1′″ performs the same operation as the fuse circuit 16-1″ of FIG. 4. That is, when the fuse F1 is cut, the control signal S1 remains at a low level as determined in a standby mode, whereas when the fuse F1 is not cut, the control signal S1 remains at a high level.

Accordingly, when the fuse F1 is cut, even if a voltage at a node n2 is enabled to a high level due to residue of the fuse F1 or before the voltage at the node n2 is enabled to the high level, the NMOS transistor N13 is turned on in response to a pulse control signal PACT so that charges are emitted from the node n2. As a result, when the fuse F1 is cut, the semiconductor device of the present embodiment can prevent change in the state of the control signal S1 due to the residue of the fuse F1. Also, even if the control signal S1 is enabled to a high level, the semiconductor device of the present embodiment can restore the control signal S1 to a low level.

That is, the semiconductor memory device having the fuse circuits 16-1′″ to 16-n′″ as shown in FIG. 5 can reduce a leakage current to reduce a voltage drop in an internal power supply voltage IVC in a standby mode when the fuse F1 is not cut, and can prevent change in the state of a control signal due to residue of the fuse F1 or reset the control signal to a desired level when the fuse F1 is cut.

In another embodiment, not an internal power supply voltage IVC but an external power supply voltage EVC is applied as a power supply voltage to the fuse circuits of FIGS. 3 through 5. Also, in further another exemplary embodiment, a semiconductor memory device may be structured such that an active internal power supply voltage generator 12 of FIGS. 3 through 5 operates not only in an active mode but also in an initial stage of a standby mode. That is, the active internal power supply voltage generator 12 may operate until a voltage at a node n1 reaches a threshold voltage Vt of an inverter I1.

Further, the control signal generator 18 of FIGS. 4 and 5 may generate the pulse control signal PACT not in response to the active command ACT output from the command decoder 10 but in response to a mode set command ACT output from the command decoder 10.

In typical semiconductor devices having a semiconductor memory device, the command decoder 10 issues a mode set command, a write command, a read command, a precharge command, and a refresh command and sets one of various operating modes in response to the mode set command. Accordingly, the control signal generator 18 may generate the pulse control signal PACT in response to one of commands other than the above-described active command and mode set command.

In addition, in order to lower the threshold voltages of the NMOS transistors shown in FIGS. 3 through 5, impurities may be implanted into channels of the NMOS transistors at different concentrations during a fabrication process. Any other known methods may be freely used to lower the threshold voltage of the NMOS transistors, or the NMOS transistors may be replaced by other known elements with a low threshold voltage.

As described above, a semiconductor device having fuse circuits according to the present invention can reduce an undesired leakage current when fuses are not cut, and also prevent change in the state of control signals when the fuses are cut. As a consequence, the semiconductor device can be improved in operating performance.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A semiconductor device having a plurality of fuse circuits, each fuse circuit comprising:
a first signal generator generating a first signal to a first node in response to a power-up signal;
a pull-down transistor pulling down a second node in response to the first signal;
a pull-up transistor and a fuse which are connected in series between a power supply voltage and the second node and pulling up the second node in repsonse to the first signal when the fuse is not cut;
a buffer buffering a signal output from the second node and generating a control signal; and
a standby reset transistor resetting the second node in response to the control signal output from the buffer;
wherein the pull-down transistor and the standby reset transistor have lower threshold voltages than that of the buffer.

2. The semiconductor device according to claim 1, wherein the buffer includes a first inverter and a second inverter that are cascade-connected to generate the control signal, the standby reset transistor resetting the second node in response to an output signal of the second inverter.

3. The semiconductor device according to claim 2, wherein the standby reset transistor is an NMOS transistor.

4. The semiconductor device according to claim 1, wherein the power supply voltage is an external power supply voltage which is applied from an exterior.

5. The semiconductor device according to claim 1, further comprising:
a command decoder decoding an externally applied command signal and generating an active command;
a standby internal power supply generator generating an internal power supply voltage in a standby mode and an active mode when receiving an external power supply voltage which is applied from an exterior;
an active internal power supply voltage generator generating the internal power supply voltage using the external power supply voltage in response to the active command;
a control signal generator generating a reset control signal, which is enabled for a predetermined duration of time, in response to the active command; and
a power-up signal generator generating the power-up signal, which remains at a first level until the external power supply voltage reaches a predetermined level when receiving the external power supply voltage, makes a transition from the first level to a second level when the external power supply voltage reaches the predetermined level, and makes a transition with a level variation of the external power supply voltage.

6. The semiconductor device according to claim 5, wherein the active internal power supply generator generates the internal power supply voltage using the external power supply voltage until a voltage at the first node reaches a predetermined level.

7. The semiconductor device according to claim 5, wherein the power supply voltage is an internal power supply voltage which is generated from an interior.

8. The semiconductor device according to claim 5, wherein each fuse circuit further includes an active reset transistor resetting the second node in response to the reset control signal.

9. The semiconductor device according to claim 8, wherein the active reset transistor has a lower threshold voltage than that of the buffer.

10. The semiconductor device according to claim 9, wherein the active reset transistor is an NMOS transistor.

11. A semiconductor device comprising:
a command decoder decoding an externally applied command signal and generating an active command;
a standby internal power supply voltage generator generating an internal power supply voltage in a standby mode and an active mode when receiving an external power supply voltage;
an active internal power supply voltage generator generating the internal power supply voltage using the external power supply voltage in response to the active command;
a control signal generator generating a reset control signal, which is enabled for a predetermined duration of time, in response to the active command;
a power-up signal generator generating a power-up signal, which remains at a first level until the external power supply voltage reaches a predetermined level when receiving the external power supply voltage, makes a transition from the first level to a second level when the external power supply voltage reaches the predetermined level, and makes a transition with a level variation of the external power supply voltage; and
a plurality of fuse circuits, each fuse circuit including a first signal generator generating a first signal to a first node in response to the power-up signal, a pull-down transistor pulling down a second node in response to the first signal, a pull-up transistor and a fuse which are connected in series between a power supply voltage and the second node and pulling up the second node in repsonse to the first signal when the fuse is not cut, a buffer buffering a signal output from the second node and generating a control signal, a standby reset transistor resetting the second node in response to the control signal output from the buffer in the standby mode, and an active reset transistor resetting the second node in the active mode in response to the reset control signal.

12. The semiconductor device according to claim 11, wherein the buffer includes a first inverter and a second inverter that are cascade-connected to generate the control signal, and the standby reset transistor resets the second node in response to an output signal of the second inverter.

13. The semiconductor device according to claim 11, wherein the power supply voltage is an external power supply voltage which is applied from an exterior.

14. The semiconductor device according to claim 11, wherein the power supply voltage is an internal power supply voltage which is generated from an interior.

15. The semiconductor device according to claim 11, wherein the standby reset transistor and the active reset transistor have lower threshold voltages than that of the buffer.

16. The semiconductor device according to claim 15, wherein the standby reset transistor is an NMOS transistor.

17. The semiconductor device according to claim 15, wherein the active reset transistor is an NMOS transistor.

18. The semiconductor device according to claim 11, wherein the active internal power supply generator generates the internal power supply voltage using the external power supply voltage until a voltage at the first node reaches a predetermined level.
